(19) United States
(12) Patent Application Publication
(10) Pub. No.: US 2004/0047629 A1
(43) Pub. Date: Mar. 11, 2004

(54) Adaptor arrangement for detecting faults in an optically amplified multi-span transmission system using a remotely located OTDR

(75) Inventors: Stephen G. Evangelides JR., Red Bank, NJ (US); Jay P. Morreale, Summit, NJ (US); Michael J. Neubelt, Little Silver, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Red Sky Systems, Inc.

(21) Appl. No.: 10/462,011

(22) Filed: Jun. 13, 2003

Related U.S. Application Data
(60) Provisional application No. 60/404,609, filed on Aug. 20, 2002.

(51) Int. Cl. H04B 10/08

(52) U.S. Cl. 398/33; 398/84; 398/102

(57) ABSTRACT

A method is provided for using OTDR with a bi-directional optical transmission system that includes first and second terminals interconnected by at least first and second unidirectional optical transmission paths having at least one repeater therein. The method begins by transmitting optical probe signals over the first optical path and receiving over the second optical path returned OTDR signals in which status information concerning the first optical path is embodied. The optical probe signals and the returned OTDR signals are transmitted and received, respectively, at time intervals allowing individual spans of the first optical path, which are separated by the repeater or repeaters, to be monitored in a sequential manner.

### STATEMENT OF RELATED APPLICATION

This application claims the benefit of priority to U.S. Provisional Patent Application No. 60/404,609 filed Aug. 20, 2002, and entitled “Gated OTDR Line Performance Monitoring.”

### FIELD OF THE INVENTION

The present invention relates generally to optical transmission systems, and more particularly to the use of an arrangement to allow optical time domain reflectometry (OTDR) to be used to detect faults in the optical transmission path of an optical transmission system consisting of multiple spans of fiber and optical amplifiers.

### BACKGROUND OF THE INVENTION

A typical long-range optical transmission system includes a pair of unidirectional optical fibers that support optical signals traveling in opposite directions. An optical signal is attenuated over long distances. Therefore, the optical fibers typically include multiple repeaters that are spaced apart from one another. The repeaters include optical amplifiers that amplify the incoming, attenuated optical signals. The repeaters also include an optical isolator that limits the propagation of the optical signal to a single direction.

In long-range optical transmission systems it is important to monitor the health of the system. For example, monitoring can be used to detect faults or breaks in the fiber optic cable such as attenuation in the optical fiber and splice loss, faulty repeaters or amplifiers or other problems with the system. Optical time domain reflectometry (OTDR) is one technique used to remotely detect faults in optical transmission systems. In OTDR, an optical pulse is launched into an optical fiber and backscattered signals returning to the launch end are monitored. In the event that there are discontinuities such as faults or splices in the fiber, the amount of backscattering generally changes and such change is detected in the monitored signals. Since backscattering and reflection also occurs from elements such as couplers, the monitored OTDR signals are usually compared with a reference record, new peaks and other changes in the monitored signal level being indicative of changes in the fiber path, normally indicating a fault. The time between pulse launch and receipt of a backscattered signal is proportional to the distance along the fiber to the source of the backscattering, thus allowing the fault to be located.

FIG. 1 shows a single fiber span 102 that is monitored by a conventional OTDR device 101. FIG. 2 shows the backscattered power on a logarithmic scale versus the distance along the fiber span 102 from the OTDR 101. The trace reveals the exact attenuation profile of the fiber, which might be used, for example, for fault localization. In FIG. 1 a conventional OTDR optical pulse is launched into the fiber span 102 and the backscattered light from that pulse travels back to the OTDR 101 in the reverse direction along the same fiber span. Because the same fiber is used for the outgoing and returning signal, this technique cannot be used with a transmission path that includes repeaters since isolators prevent the backscattered signal from reaching the OTDR. Accordingly, this technique can only be used to monitor a single span of such a multi-span, repeatered transmission path. Long repeatered transmission systems with multiple spans get around this difficulty by adding optical loopback paths after each repeater to allow the backscattered light from each span to bypass the isolator in the repeater. Typically the backscattered light is then routed back along the parallel optical path in the return direction.

FIG. 3 shows a simplified block diagram of a wavelength division multiplexed (WDM) transmission system that employs a conventional OTDR configured to operate with a separate return path for the backscattered light. The transmission path is segmented into transmission spans or links 130₁, 130₂, 130₃, . . . 130ₙ₊₁. The transmission spans 130, which are concatenated by optical amplifiers 112₁, 112₂, . . . 112ₙ (or repeaters 114₁, 114₂, . . . 114ₙ), can range from 40 to 120 km in length. The terminal 110 includes an OTDR unit 105. In operation, OTDR unit 105 generates an optical pulse onto its input/output port 111 that is launched into optical fiber 106 via a multiplexer (not shown) located in terminal 110. The optical pulse serves as the OTDR probe signal. Because optical isolators 115 located downstream from each optical amplifier 106 prevent the OTDR probe signal from being reflected and backscattered to the OTDR 105 on fiber 106, each repeater 114 includes a coupler arrangement providing an optical path for use by the backscattered light at the OTDR wavelength. In particular, signals generated by reflection and scattering of the probe signal on fiber 106 between adjacent repeaters enter coupler 118 and are coupled onto the opposite-going fiber 108 via coupler 122. The OTDR signal then travels along with the data on optical fiber 108. OTDR 107 operates in a similar manner to generate OTDR signals that are reflected and scattered on fiber 108 so that they are returned to OTDR 107 along optical fiber 106. FIG. 4 shows a typical trace of the backscattered power on a logarithmic scale versus the distance from the OTDR for the transmission spans 130₁, 130₂, 130₃, . . . 130ₙ₊₁ depicted in FIG. 3.

The OTDR measurement process is limited by signal-to-noise ratio considerations. To increase the signal to noise ratio, a series of optical pulses are generally transmitted with a repetition rate such that each pulse is transmitted just as the backscattered portions of the previous pulse are arriving for detection. Then the backscattered signals corresponding to each of outgoing pulses are averaged.

A number of problems arise when an OTDR arrangement is used in a multi-span, optically amplified transmission system such as shown in FIG. 3. For example, a typical OTDR system is designed to monitor a single fiber span having a length of 120 km or less, where the backscattered pulse is spread over about 1 ms in time. To avoid overlap between the backscattered pulses, the repetition rate for the original outgoing optical pulses must be about 1 KHz or less. Unfortunately, for long-haul, multi-span, optically amplified transmission systems such as depicted in FIG. 3, in which the total transmission path may be up to 10,000 km in length, the backscattered pulse is spread over about 100 ms, so that the repetition rate for the outgoing pulse must be limited to as low as 10 Hz to avoid overlap between the broadened backscattered pulses. Thus the OTDR pulse repetition rate must be slowed down considerably.

Another problem is the backscattered light from the transmission spans in a multi-span system are routed back to the OTDR terminal on a separate fiber, as shown in FIG. 3. Since OTDR systems are designed to operate over a single fiber as in FIG. 1, they generally only have provision for a single fiber interface (e.g., input/output port 111 in FIG. 3) that both transmits the outgoing pulse and receives the backscattered pulse. Moreover, the return path for the backscattered light uses the opposite-going transmission path, which also contains optical amplifiers. Consequently, the backscattered signals are further corrupted by amplified spontaneous noise (ASE) arising from the optical amplifiers in the return path, a problem that does not arise when an OTDR is used to monitor a single, unamplified fiber span.

A technique similar to OTDR is coherent optical time domain reflectometry (COTDR). COTDR systems are specially designed to operate on multi-span fiber transmission systems such as portrayed in FIG. 3. Such systems have separate ports for the output and input optical signals, and the pulse repetition rate is set to allow for the much longer return paths employed in longer multi-span systems. Also, COTDR systems improve on OTDR systems by using a coherent detection scheme similar to that employed in heterodyne radio receivers. The advantages of COTDR over OTDR include an increase in the signal-to-noise ratio and a corresponding reduction in the analysis time, with no sacrifice in spatial resolution. While COTR has a number of advantages over OTDR, one disadvantage of a COTDR arrangement is that the relatively complex components it requires makes a COTDR arrangement substantially more expensive than an OTDR arrangement.

Accordingly, it would be desirable to provide an arrangement that would make it possible to use an OTDR system designed to characterize single span routes such as in FIG. 1, for a multi-span, optically amplified transmission system such as shown in FIG. 3. The arrangement uses a separate optically amplified return path, controls the repetition rate of the outgoing pulse to be suitable for long transmission systems, while still being able to tolerate the ASE noise added on the return path.

### SUMMARY OF THE INVENTION

In a bi-directional optical transmission system that includes first and second terminals interconnected by at least first and second unidirectional optical transmission paths having at least one repeater therein, the present invention provides an OTDR arrangement. The OTDR arrangement includes an OTDR unit associated with the first terminal transmitting optical probe signals over the first optical path and receiving over the second optical path returned OTDR signals in which status information concerning the first optical path is embodied. A gating arrangement is also provided for triggering the OTDR unit so that the optical probe signals and the returned OTDR signals are transmitted and received, respectively, at time intervals allowing individual spans of the first optical path, which are separated by the repeater or repeaters, to be monitored in a sequential manner.

In accordance with one aspect of the invention, the OTDR unit includes an OTDR device having a common optical input/output interface through which the optical probe signals and the returned OTDR signals are communicated. Additionally, the gating arrangement has a first optical port in optical communication with the common interface and second and third ports in optical communication with the first and second optical paths, respectively.

In accordance with another aspect of the invention, the gating arrangement further comprises a three-port optical circulator having first, second, and third circulator ports. The first, second and third circulator ports are optically coupled, respectively, to the first, second, and third optical ports of the gating arrangement.

In accordance with another aspect of the invention, the gating arrangement further comprises an input optical switch and an output optical switch. The input optical switch is located between the third circulator port of the optical circulator and the third port of the gating arrangement. The output optical switch is located between the second circulator port of the optical circulator and the second port of the gating arrangement.

In accordance with another aspect of the invention, the output optical switch and the input optical switch are activated to respectively communicate the optical probe signals and the returned OTDR signals between the OTDR device and respective ones of the optical paths at the time intervals.

In accordance with another aspect of the invention, the time interval between an optical probe signal and its corresponding returned OTDR signal is equal to a roundtrip signal delay between the OTDR unit and a selected one of the spans to be monitored.

In accordance with another aspect of the invention, the repeater includes a rare-earth doped optical amplifier through which the optical probe signal is transmitted.

In accordance with another aspect of the invention, at least one optical loopback path is provided for optically coupling the first optical path to the second optical path.

In accordance with another aspect of the invention, the optical loopback path is located in the repeater.

In accordance with another aspect of the invention, a method is provided for using OTDR with a bi-directional optical transmission system that includes first and second terminals interconnected by at least first and second unidirectional optical transmission paths having at least one repeater therein. The method begins by transmitting optical probe signals over the first optical path and receiving over the second optical path returned OTDR signals in which status information concerning the first optical path is embodied. The optical probe signals and the returned OTDR signals are transmitted and received, respectively, at time intervals allowing individual spans of the first optical path, which are separated by the repeater or repeaters, to be monitored in a sequential manner.

### BRIEF DESCRIPTION OF THE DRAWINGS

FIG. 1 shows a simplified block diagram of a single fiber span that is monitored by a conventional OTDR arrangement.

FIG. 2 shows a graphic display of typical OTDR trace showing the backscattered power versus the distance from the OTDR for the transmission span depicted in FIG. 1.

FIG. 3 shows a simplified block diagram of a transmission system that employs an OTDR arrangement.

FIG. 4 shows a graphic display of a typical OTDR trace showing the backscattered power versus the distance from the OTDR for the transmission system depicted in FIG. 3.

FIG. 5 shows a simplified block diagram of one exemplary transmission system in accordance with the present invention that allows the use of an OTDR for multi-span routes, when triggering inputs for both transmit and receive sections of the OTDR are available.

FIG. 6 is a block diagram showing one embodiment of an OTDR adapter unit constructed in accordance with the present invention for the case when triggering inputs for both transmit and receive sections of the OTDR are available.

FIG. 7 is a diagram showing the timing of the send and receive triggers for the embodiment of the invention depicted in FIG. 6.

FIG. 8 shows a simplified block diagram of another exemplary transmission system in accordance with the present invention that allows the use of an OTDR for multi-span routes, for the case when triggering inputs for the OTDR are not available.

FIG. 9 is a block diagram showing an alternative embodiment of an OTDR adapter unit constructed in accordance with the present invention, for the case when triggering inputs for the OTDR are not available.

FIG. 10 is a diagram showing the timing of the send and receive optical gates for the embodiment of the invention depicted in FIG. 9.

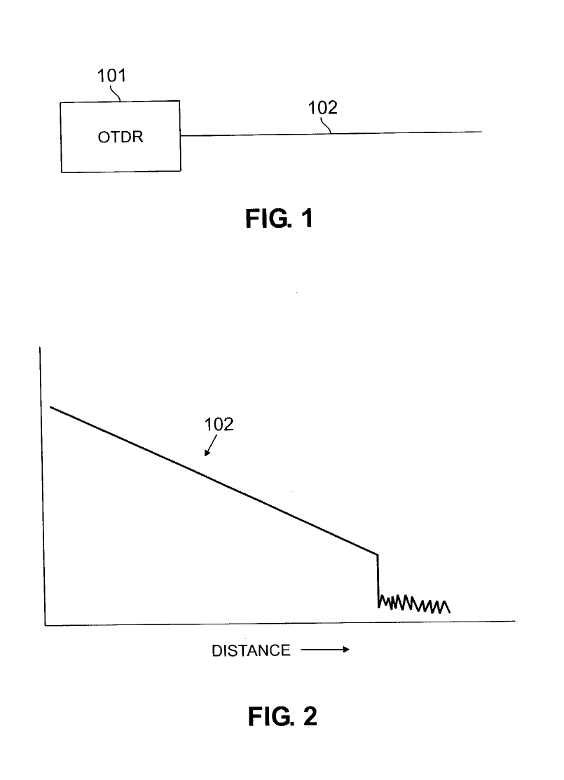

### DETAILED DESCRIPTION OF THE INVENTION

An OTDR arrangement is provided in which faults arising in a multi-span, optically amplified transmission system are examined by an OTDR probe signal, the data from which is acquired and processed on a span-by-span basis. This can be accomplished by applying a gate to the returning, backscattered optical signal so that only the signal from a single span is measured at any given time. In one embodiment of the invention, an adaptor is provided to enhance the functionality of a conventional, off-the-shelf OTDR unit.

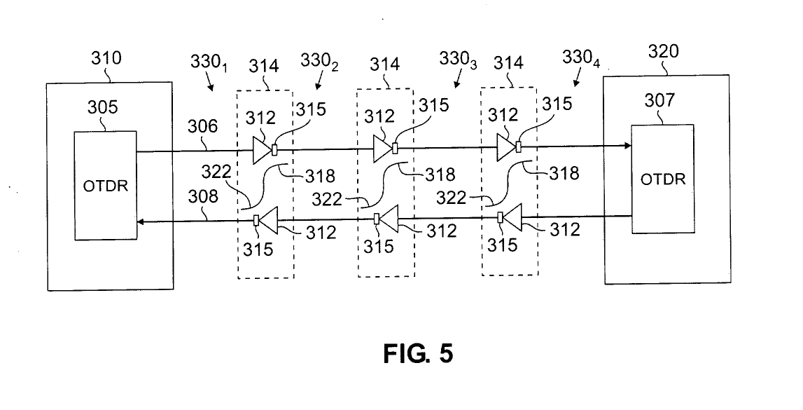

FIG. 5 shows a simplified block diagram of an exemplary wavelength division multiplexed (WDM) transmission system in accordance with the present invention. The transmission system serves to transmit a plurality of optical channels over a pair of unidirectional optical fibers 306 and 308 between terminals 310 and 320, which are remotely located with respect to one another. Terminals 310 and 320 each include transmitting and receiving unit (not shown). The transmitting unit generally includes a series of encoders and digital transmitters connected to a wavelength division multiplexer. For each WDM channel, an encoder is connected to an optical source, which, in turn, is connected to the wavelength division multiplexer. Likewise, the receiving unit includes a series of decoders, digital receivers and a wavelength division demultiplexer. Each terminal 310 and 320 includes an OTDR unit 305 and 307, respectively.

Optical amplifiers 312 are located along the fibers 306 and 308 to amplify the optical signals as they travel along the transmission path. The optical amplifiers may be rare-earth doped optical amplifiers such as erbium doped fiber amplifiers that use erbium as the gain medium. As indicated in FIG. 5, a pair of rare-earth doped optical amplifiers supporting opposite-traveling signals is often housed in a single unit known as a repeater 314. The transmission path comprising optical fibers 306-308 are segmented into transmission spans 330₁-330₄, which are concatenated by the repeaters 314. While only three repeaters 314 are depicted in FIG. 5 for clarity of discussion, it should be understood by those skilled in the art that the present invention finds application in transmission paths of all lengths having many additional (or fewer) sets of such repeaters. Optical isolators 315 are located downstream from the optical amplifiers 220 to eliminate backwards propagating light and to eliminate multiple path interference.

Each repeater 314 includes a coupler arrangement providing an optical path for use by the OTDR. In particular, signals generated by reflection and scattering of the probe signal on fiber 306 between adjacent repeaters enter coupler 318 and are coupled onto the opposite-going fiber 308 via coupler 322. The OTDR signal then travels along with the data on optical fiber 308. OTDR 307 operates in a similar manner to generate OTDR signals that are reflected and scattered on fiber 308 so that they are returned to OTDR 307 along optical fiber 306. The signal arriving back at the OTDR is then used to provide information about the loss characteristics of each span.

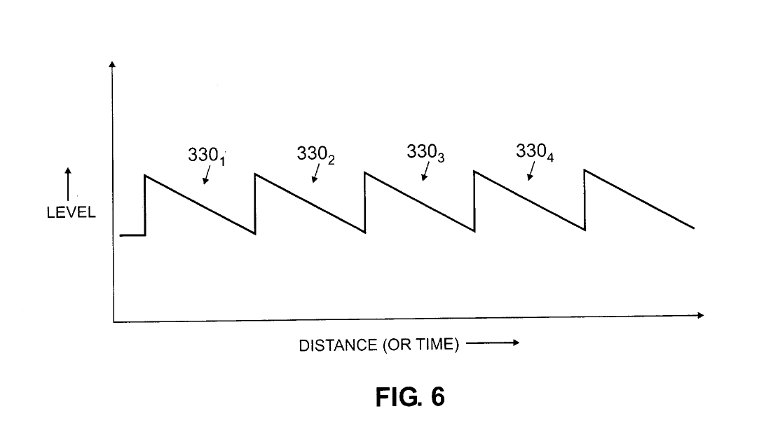

In the present invention, OTDR units 305 and 307 are configured to allow an OTDR technique to be more effectively used in the multi-span, optically amplified configuration shown in FIG. 5. This can be accomplished by applying a gate to the returning, backscattered signal so that only the signal from a single span is measured at any given time. The gate can be implemented electronically or optically. Since a single span is about 50 to 120 km in length, which corresponds to a spread in the backscattered pulse of about 1 ms, the backscattered pulse is gated in approximately 1 ms segments. For example, in the trace depicted in FIG. 6, the gate may be placed around a 1 ms segment of the backscattered pulse that corresponds to one of the transmission spans 330₁-330₄ in FIG. 5. After sufficient data is acquired with respect to transmission span 304₁, the gate can be moved about a different 1 ms segment of the backscattered pulse corresponding to a different transmission span. In this way the OTDR data can be obtained for the entire transmission path by measuring each individual transmission span in a sequential manner.

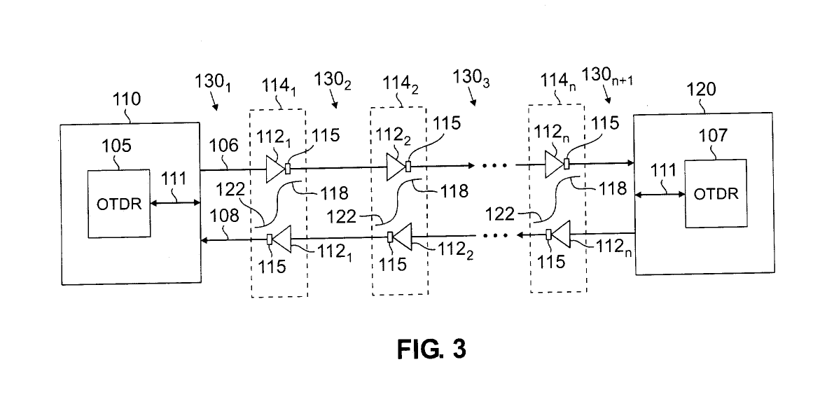

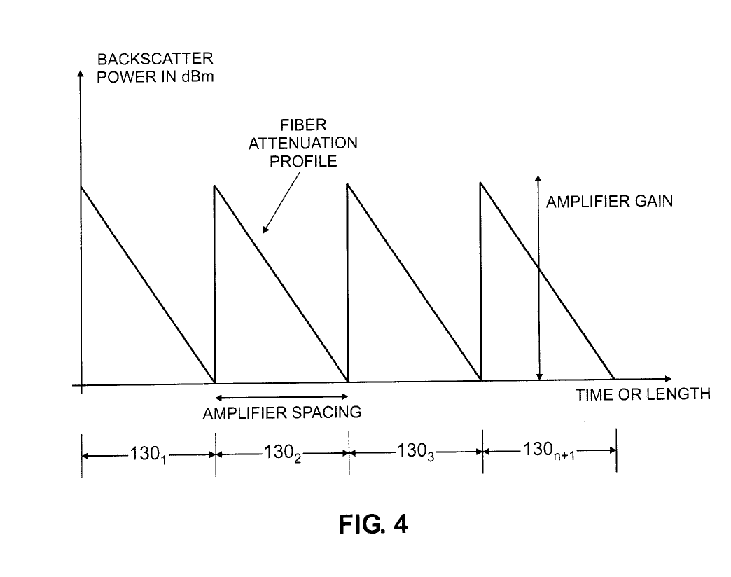

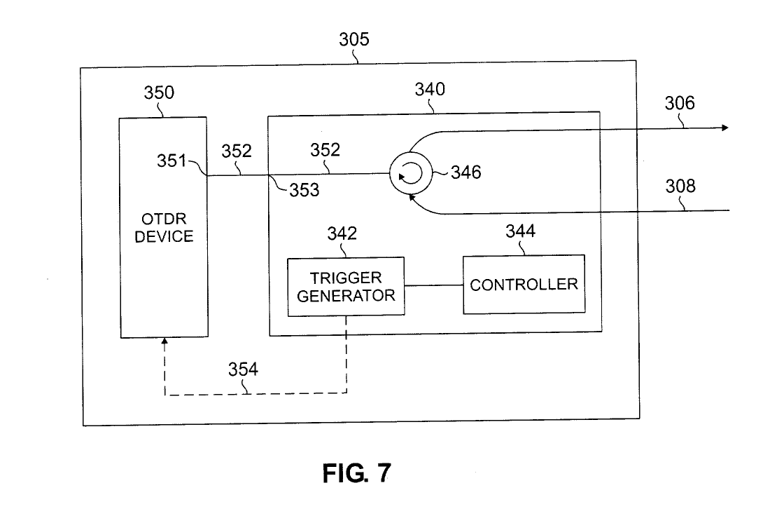

FIG. 7 is a block diagram showing one embodiment of an OTDR unit that may serve as one of the OTDR units 305 and 307 constructed in accordance with the present invention. In this embodiment of the invention the OTDR unit 305 includes a conventional OTDR device 350 (e.g., OTDR devices 105 and 107 shown in FIG. 3) for generating the OTDR signals and receiving and analyzing the backscattered signals to produce an attenuation profile from which faults or other abnormalities in the transmission path can be determined. The OTDR unit 305 also includes an OTDR adaptor 340, which will be discussed in more detail below. In this embodiment of the invention, OTDR device 350 is assumed to include internal circuitry that allows the outgoing OTDR optical signals and the incoming, backscattered optical signals to be transmitted and received, respectively, in accordance with input triggering signals. Since OTDR device 350 is well known to those of ordinary skill in the art, it need not be discussed in further detail herein.

The OTDR adaptor 340 includes a trigger pulse generator 342, a controller 344, and an optical circulator 346. The controller 344 determines the timing at which the trigger generator 342 sends an electrical trigger pulse to the OTDR device 350 via electrical path 354. Upon receiving the trigger pulse from the trigger generator 342, the OTDR device 350 launches the optical OTDR signal via its optical interface 351 onto optical path 352, which in turn is connected to the optical interface 353 of the OTDR adaptor 340. The optical OTDR signal is received in the adaptor 340 by a three-port optical circulator 346. Optical circulator 346 directs the OTDR signal received on optical path 352 to the outgoing transmission fiber 306 seen in FIG. 5. The backscattered signal is returned to the optical circulator 346 along the opposite going transmission fiber 308. The circulator 346, in turn, directs the backscattered signal back to the OTDR device 350 along optical path 352.

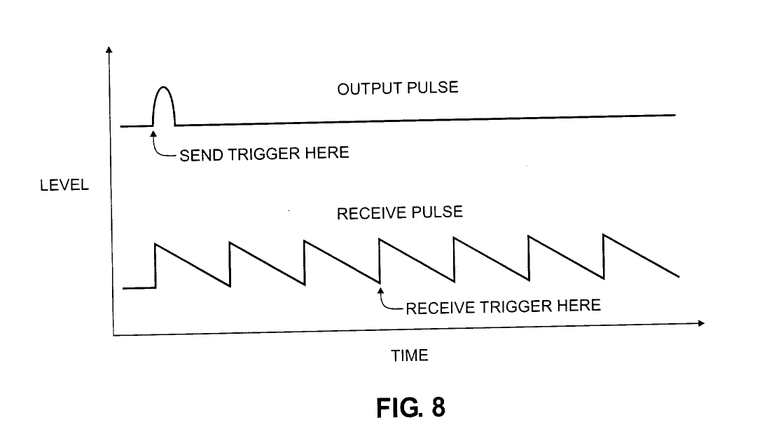

At the appropriate time the trigger generator 342 sends another trigger pulse to the OTDR device 350, which instructs the OTDR device 350 to receive the backscattered signal for analysis. This second trigger pulse is sent at an appropriate time relative to the first trigger pulse that was used to launch the OTDR signal. The time delay between the first and second trigger pulses is equal to twice the roundtrip delay from the OTDR unit 305 to the portion or span of the transmission fiber being monitored. Typically, the sweep time of the OTDR device 350 is only capable of monitoring up to 120 km of fiber at a time. As an example, the timing for the transmit trigger and for the receive trigger are shown in FIG. 8 for the case when the fourth span 3304 of the transmission path 306 is being monitored.

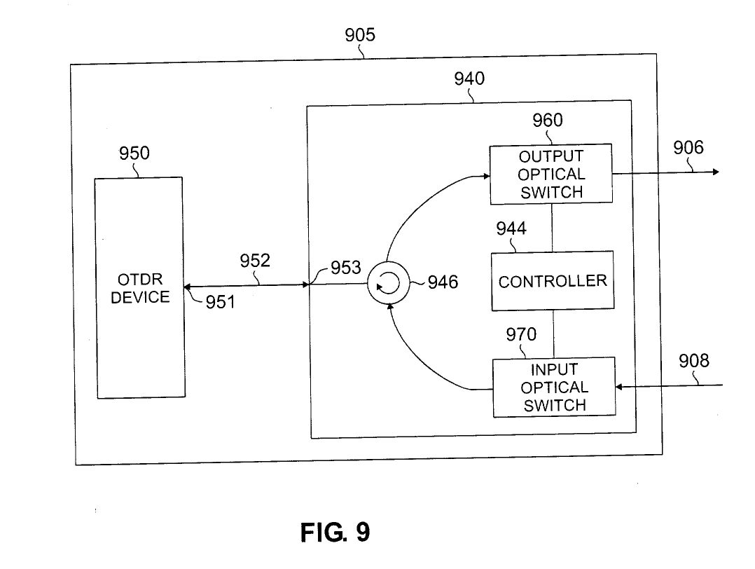

FIG. 9 is a block diagram showing one embodiment of an OTDR adaptor unit constructed in accordance with the present invention, for the case when the OTDR unit does not allow input triggering signals. As in the embodiment of FIG. 7, in this embodiment of the invention the OTDR unit 905 includes a conventional OTDR device 950 (e.g., OTDR devices 105 and 107 shown in FIG. 3) for generating the OTDR signals and receiving and analyzing the backscattered signals to produce an attenuation profile from which faults or other abnormalities in the transmission path can be determined. The OTDR unit 305 also includes an OTDR adaptor 940, which will be discussed in more detail below. In this embodiment of the invention, OTDR device 950 does not include internal circuitry that allows the outgoing OTDR optical signals and the incoming, backscattered optical signals to be transmitted and received, respectively, in accordance with input triggering signals.

The OTDR adaptor 940 includes a controller 944, an optical circulator 946, and input and output optical switches 970 and 960. The input optical switch 970 couples a port of the circulator 946 to the transmission fiber 908 on which the backscattered OTDR signal is received. The output optical switch 960 couples another port of the circulator 946 to the transmission fiber 906 on which the outgoing OTDR signal is transmitted.

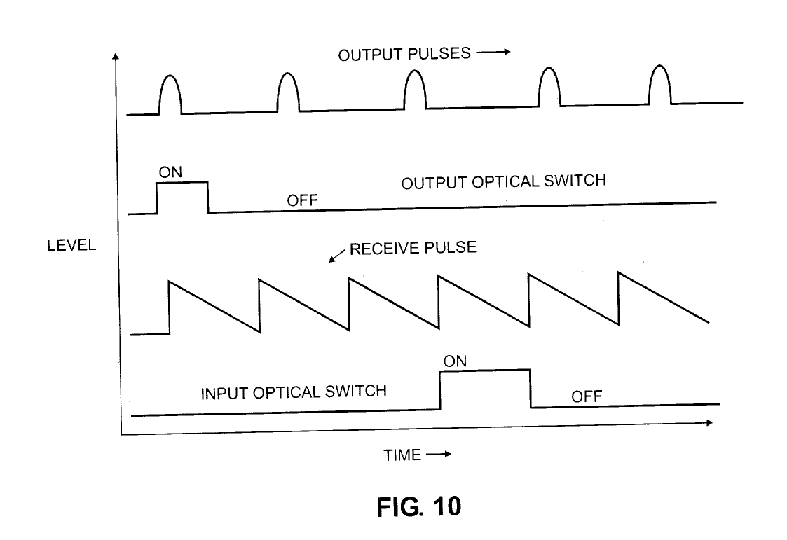

The OTDR device 950 is generally arranged to emit pulses with a fast repetition rate consistent with a 120 km of fiber, i.e. about 1 ms between pulses. The controller 944 causes the output optical switch 960 to pass one optical pulse on transmission fiber 906, and block enough of the subsequent pulses to account for the longest roundtrip travel time to the farthest section of the transmission fiber 906 being monitored. On the receive side, the controller 944 activates the input optical switch 970 for a period of about 1 ms, enough to pass a portion of the reflected and backscattered signal from a 120 km section of fiber. By varying the start time at which the input optical switch 970 is activated, different 120 km sections or spans of fiber can be monitored. The timing for the transmit optical gate (i.e., output optical switch 906) and for the receive optical gate (i.e., input optical switch 970) are shown in FIG. 10 for the case where the fourth span of the transmission path is to be monitored.

When the input optical switch 908 is activated, the reflected and backscattered OTDR signal is then received by the circulator 946, and sent back to the OTDR device 950 over the optical path 952. The receive section of the OTDR device 950 is assumed to be internally triggered so that it looks for the reflected and backscattered light from each launched pulse. Typically, the OTDR sweep time is only capable of monitoring up to 120 km of fiber at a time. In this case, only one pulse is passed into the transmission fiber 906 via the optical gate on the transmit side, and only a section of the reflected and backscattered return pulse is passed via the optical gate on the receive side back to the OTDR device 950. Since the OTDR receiver is being triggered once every 1 ms, in most cases there will be no signal when the receiver is triggered. However, when averaging is used, a signal trace for any appropriate span of the transmission line can be built up over time.

1. In a bi-directional optical transmission system that includes first and second terminals interconnected by at least first and second unidirectional optical transmission paths having at least one repeater therein, an OTDR arrangement comprising:
an OTDR unit associated with the first terminal transmitting optical probe signals over the first optical path and receiving over the second optical path returned OTDR signals in which status information concerning the first optical path is embodied;
a gating arrangement for triggering the OTDR unit so that the optical probe signals and the returned OTDR signals are transmitted and received, respectively, at time intervals allowing individual spans of the first optical path separated by the at least one repeater to be monitored in a sequential manner.

2. The OTDR arrangement of claim 1 wherein said OTDR unit includes an OTDR device having a common optical input/output interface through which the optical probe signals and the returned OTDR signals are communicated, said gating arrangement having a first optical port in optical communication with said common interface and second and third ports in optical communication with said first and second optical paths, respectively.

3. The OTDR arrangement of claim 2 wherein said gating arrangement further comprises a three-port optical circulator having first, second, and third circulator ports, said first, second and third circulator ports being optically coupled, respectively, to the first, second, and third optical ports of the gating arrangement.

4. The OTDR arrangement of claim 3 wherein said gating arrangement further comprises an input optical switch and an output optical switch, said input optical switch being located between the third circulator port of the optical circulator and the third port of the gating arrangement, said output optical switch being located between the second circulator port of the optical circulator and the second port of the gating arrangement.

5. The OTDR arrangement of claim 4 wherein the output optical switch and the input optical switch are activated to respectively communicate the optical probe signals and the returned OTDR signals between the OTDR device and respective ones of the optical paths at said time intervals.

6. The OTDR arrangement of claim 1 wherein said time interval between an optical probe signal and its corresponding returned OTDR signal is equal to a roundtrip signal delay between the OTDR unit and a selected one of the spans to be monitored.

7. The OTDR arrangement of claim 1 wherein said at least one repeater includes a rare-earth doped optical amplifier through which the optical probe signal is transmitted.

8. The OTDR arrangement of claim 1 further comprising at least one optical loopback path optically coupling the first optical path to the second optical path.

9. The OTDR arrangement of claim 8 wherein said optical loopback path is located in said repeater.

10. The OTDR arrangement of claim 8 wherein the status information includes discontinuities in the first optical path that gives rise to optical attenuation.

11. A method of using OTDR with a bi-directional optical transmission system that includes first and second terminals interconnected by at least first and second unidirectional optical transmission paths having at least one repeater therein, said method comprising the steps of:
transmitting optical probe signals over the first optical path;
receiving over the second optical path returned OTDR signals in which status information concerning the first optical path is embodied; and
wherein the optical probe signals and the returned OTDR signals are transmitted and received, respectively, at time intervals allowing individual spans of the first optical path separated by the at least one repeater to be monitored in a sequential manner.

12. The method of claim 11 wherein said transmitting step is performed by an OTDR unit that includes an OTDR device having a common optical input/output interface through which the optical probe signals and the returned OTDR signals are communicated.

13. The method of claim 12 wherein said time intervals are determined by a gating arrangement having a first optical port in optical communication with said common interface and second and third ports in optical communication with said first and second optical paths, respectively.

14. The method of claim 13 wherein said gating arrangement further comprises a three-port optical circulator having first, second, and third circulator ports, said first, second and third circulator ports being optically coupled, respectively, to the first, second, and third optical ports of the gating arrangement.

15. The method of claim 14 wherein said gating arrangement further comprises an input optical switch and an output optical switch, said input optical switch being located between the third circulator port of the optical circulator and the third port of the gating arrangement, said output optical switch being located between the second circulator port of the optical circulator and the second port of the gating arrangement.

16. The method of claim 14 wherein the output optical switch and the input optical switch are activated to respectively communicate the optical probe signals and the returned OTDR signals between the OTDR device and respective ones of the optical paths at said time intervals.

17. The method of claim 11 wherein said time interval between an optical probe signal and its corresponding returned OTDR signal is equal to a roundtrip signal delay between the OTDR unit and a selected one of the spans to be monitored.

18. The method of claim 11 wherein said at least one repeater includes a rare-earth doped optical amplifier through which the optical probe signal is transmitted.

19. The method of claim 11 further comprising the step of transmitting the returned OTDR signals from the first optical path to the second optical path over an optical loopback path.

20. The method of claim 19 wherein said optical loopback path is located in said repeater.

21. The method of claim 11 wherein the status information includes discontinuities in the first optical path that gives rise to optical attenuation.
